(19) United States
(12) Patent Application Publication
(10) Pub. No.: US 2018/0178354 A1
(43) Pub. Date: Jun. 28, 2018

(54) CONTAINER SEAL REMOVAL DEVICE

(71) Applicant: Karen Schibig, Sacramento, CA (US)

(72) Inventor: Karen Schibig, Sacramento, CA (US)

(21) Appl. No.: 15/831,351

(22) Filed: Dec. 4, 2017

Related U.S. Application Data
(60) Provisional application No. 62/439,449, filed on Dec. 27, 2016.

(51) Int. Cl. B25B 9/02; B67B 7/16; B67B 7/12

(52) U.S. Cl. CPC B25B 9/02; B25J 1/02; B67B 7/12; B67B 7/162

(57) ABSTRACT

A device includes a body, a first arm-member, a second arm-member and a curved-end. The device is useful for gripping and removing a seal from an object via biasing means. In particular, the device is useful for removing an airtight seal from a container. The containers may include medication, food products, etc. The device may be of particular use for users who do not possess necessary hand dexterity and may eliminate the need for individuals to seek assistance to access food or medication.

### CROSS REFERENCE TO RELATED APPLICATION

The present application is related to and claims priority to U.S. Provisional Patent Application No. 62/439,449 filed Dec. 27, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of gripping devices and more specifically relates to a device for gripping and removing a seal from a container.

### 2. Description of Related Art

Many containers, such as food items and medications, have a tight foil or paper seal when packaged. This covering is designed to be removed by peeling it back. However, the tab provided is small and difficult to grasp. The seal is often so tight, that individuals do not have the strength to remove it. Attempts to remove it can result in injuries. This is especially true for individuals with limited dexerity, grip, or strength. Without assistance, they are often not able to access their medication or food items. Thus, a suitable solution is desired.

U.S. Pat. No. 4,613,179 to Willem D. van Zelm relates to a hand-held gripping device with improved support for handicapped persons having limited finger function or wrist strength. The described hand-held gripping device with improved support for handicapped persons having limited finger function or wrist strength includes a thumb support element, a wrist brace element and an arm support element. These respective elements may be quickly mounted on either side of the device, thereby enabling the device to be used by either right-handed or left-handed persons. A lanyard including a noose is also provided to facilitate convenient manipulation of the gripping device by the free hand of the user. A toggle mechanism includes an over-the-center spring for controlling a pair of gripping tongs.

### BRIEF SUMMARY OF THE INVENTION

In view of the foregoing disadvantages inherent in the known gripping devices art, the present disclosure provides a novel container seal removal device. The general purpose of the present disclosure, which will be described subsequently in greater detail, is to provide a device for gripping a seal on a container, and for removing the seal from the container. The device may be of particular use for users who do not possess necessary hand dexterity, and may eliminate the need for individuals to seek assistance to access food or medication.

A device is disclosed herein. The device includes a body which may include a continuous length formed into a substantially U-shaped (arcuate) configuration. The U-shaped configuration may include a first arm-member having a first gripping-tip, a second arm-member having a second gripping-tip and a curved-end connecting the first arm-member and the second arm-member in a substantially arcuate-bend. The first arm-member and the second arm-member may be able to move between an open-configuration and a closed-configuration via hand manipulation. The open-configuration may include the first-arm member and the second arm-member being substantially parallel and having a space therebetween, and the closed-configuration may include the first gripping-tip and the second-gripping tip being pressed together and being configured to biasingly-grip the seal on an object such that the seal may be able to be manipulated in relation to the object.

A method of using device is also disclosed herein. The method of using the device may comprise the steps of: providing the device as above further including a handle-means; holding the handle-means; placing the seal on the object into the space of the open-configuration, between the first gripping-tip and the second gripping-tip; squeezing the handle-means to move the first arm-member and the second arm-member from the open-configuration into the closed-configuration, such that the first gripping-tip and the second gripping-tip biasingly-grip the seal on the object; gripping the seal on the object with the device; pulling the seal on the object away from the object with the device; and removing the seal from the object.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a container seal removal device, constructed and operative according to the teachings of the present disclosure.

FIG. 1 is a side-front perspective view of the device during an ‘in-use’ condition, according to an embodiment of the disclosure.

FIG. 2 is a side-top perspective view of the device of FIG. 1, according to an embodiment of the present disclosure.

FIG. 3 are front and side perspective views of the device of FIG. 1, according to an embodiment of the present disclosure.

FIG. 4 are side perspective views of the device of FIG. 1, according to an embodiment of the present disclosure.

FIG. 5 is a flow diagram illustrating a method of use for the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to gripping devices and more particularly to a container seal removal device as used to improve the gripping and removing means for removing a seal from a container.

Generally disclosed is a device that facilitates easy removal of a paper or foil covering on the top of a container. This may enable individuals with limited strength or grip, or those individuals who have difficulty pulling tabs, to easily remove a tightly sealed cover from a container. It may allow for the easy opening of peanut butter jars, medication bottles, yogurt containers, and more. Further, it may prevent injury to the skin, fingers, or nails caused by an attempt to lift the seal.

The device may provide users with a handheld device for removing the paper or foil seal on jars and containers. The device may be comprised of a hand tool with an easy to grasp handle and tip for gripping objects. When pressed together, the design may enable the object to be held tightly, but can then be released easily. The unit may be made from metal, and both the handle portion and the tip portion may be lined with a gripping rubber for stability. A variation made of all rubber may be available.

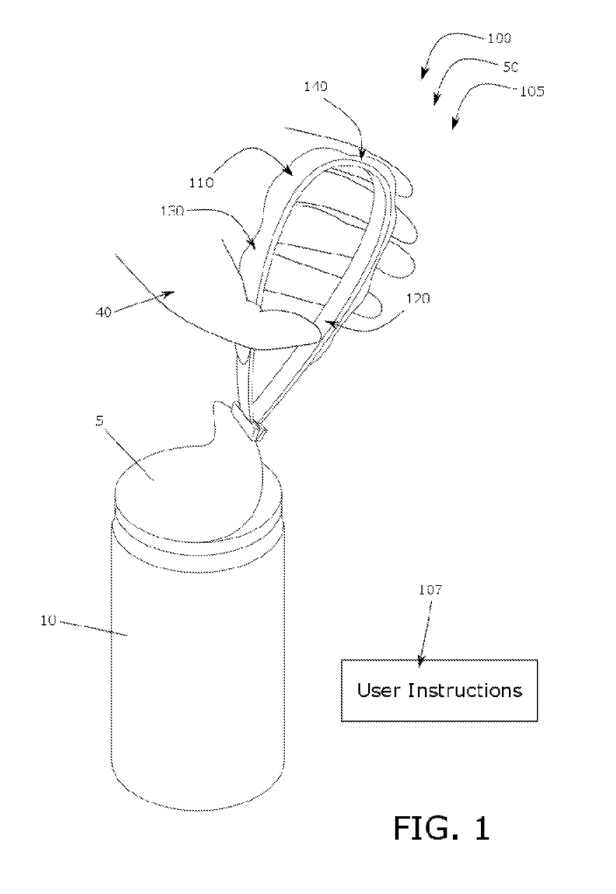

Referring now more specifically to the drawings by numerals of reference, there is shown in FIGS. 1-4, various views of a device 100.

FIG. 1 shows a device 100 during an ‘in-use’ condition 150, according to an embodiment of the present disclosure. As illustrated, the device 100 may include a body 110, a first arm-member 120, a second arm-member 130 and a curved-end 140. As illustrated, the device 100 may be used for gripping and removing a seal 5 from an object 10. In a preferred embodiment the seal 5 may be an airtight seal. Here, the object 10 is a food product container including the airtight seal, and a user 40 is shown gripping and removing the airtight seal from the food product container.

According to one embodiment, the device 100 may be arranged as a kit 105. The kit 105 may include set of user instructions 107. The instructions 107 may detail functional relationships in relation to the structure of the device 100 (such that the device 100 can be used, maintained, or the like, in a preferred manner).

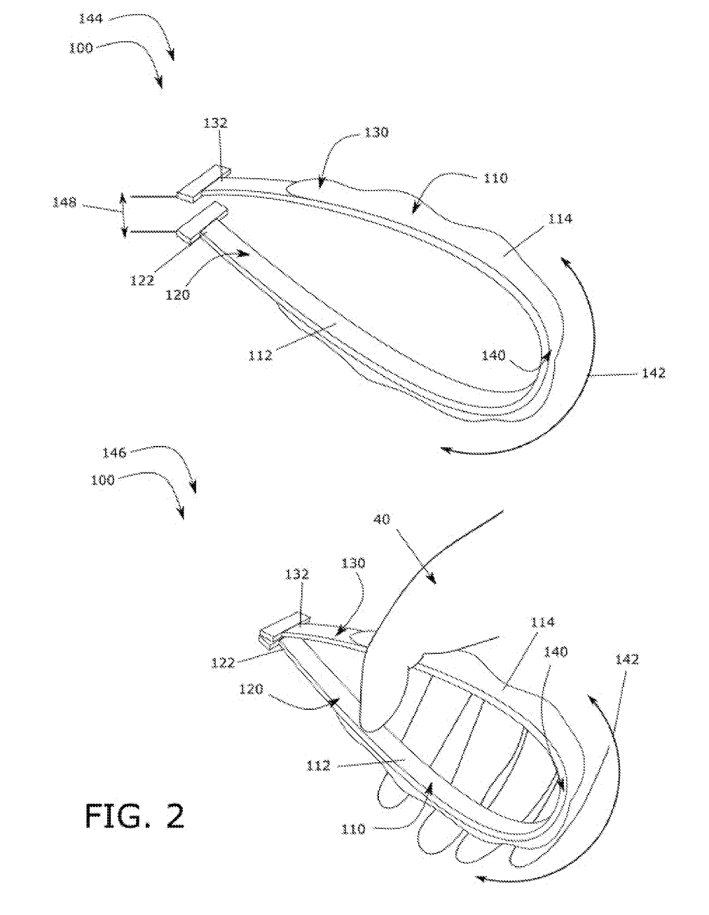

FIG. 2 shows a side-top perspective view of the device 100 of FIG. 1, according to an embodiment of the present disclosure. Illustrated here is the device shown in an open-configuration 144 and a closed-configuration 146. As shown, the body 110 may include a continuous length 112 formed into a substantially U-shaped configuration 114. The U-shaped configuration 114 may include the first arm-member 120 having a first gripping-tip 122, a second arm-member 130 having a second gripping-tip 132, and the curved-end 140 connecting the first arm-member 120 and the second arm-member 130 in a substantially arcuate-bend 142.

As illustrated, the first arm-member 120 and the second arm-member 130 may be able to move between the open-configuration 144 and the closed-configuration 146. The open-configuration 144 may include the first-arm member and the second arm-member 130 being substantially parallel and having a space 148 therebetween, and the closed-configuration 146 may include the first gripping-tip 122 and the second-gripping tip being pressed together and being configured to biasingly-grip the seal 5 on the object 10 such that the seal 5 is able to be manipulated in relation to the object 10 (FIG. 1). As shown, the first arm-member 120 and the second arm-member 130 may be equal in length to aid in gripping of the seal 5 (FIG. 1).

The first gripping-member and the second gripping-member may be biased in the open-configuration 144 via the substantially arcuate-bend 142. In use, a user may apply a force to the first arm-member 120 and the second arm-member 130 to urge the first-gripping member and the second-gripping member into the closed-configuration 146 to biasingly-grip the seal 5 on the object 10 (FIG. 1) (as illustrated here, the force may be applied via squeezing the device 100 with a hand of the user 40). The substantially arcuate-bend 142 may be particularly useful for providing an improved ability for the device 100 to flex, thus providing an improved grip on the seal 5 on the object 10 (FIG. 1) and an improved release of the grip. Further, the improved ability to flex may prevent the user from having to apply a strong force on the first arm-member 120 and the second arm-member 130 to urge the same into the closed-configuration 146. This may be particularly useful for the individuals with limited strength or grip.

Further to this, the body 110 may be made from a flexible, resilient material configured for manipulation between the open-configuration 144 and the closed-configuration 146. This flexible, resilient material may further aid in the improved ability to flex. In the preferred embodiment, the flexible, resilient material may be a spring-metal material. In another embodiment, the flexible, resilient material may be a rubber material or a plastic material. However, it should be appreciated that other materials may be used.

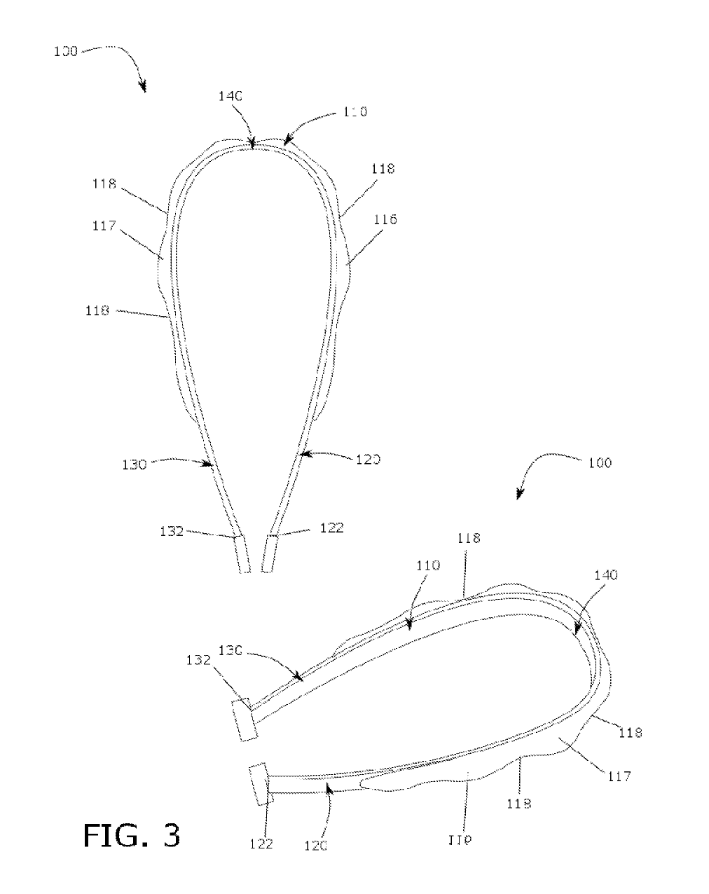

FIG. 3 shows a front perspective view of the device 100 of FIG. 1, and a side perspective view of the device 100 of FIG. 1, according to an embodiment of the present disclosure. Illustrated here is a handle-means 117 of the device 100. As shown, the body 110 may include a non-slip material 116 located around a perimeter of the U-shaped configuration 114 and terminating before the first gripping-tip 122 and the second gripping-tip 132. In this embodiment, the non-slip material 116 may be configured to provide the handle-means 117 for a hand of the user 40 (FIG. 2) to aid in applying the force as above. Further, the non-slip material 116 may additionally include a plurality of finger receiving grooves 118 to provide the user with additional gripping ability. In the preferred embodiment, the non-slip material 116 may be the rubber material. In another embodiment, the non-slip material 116 may be a silicone material. However, any suitable material may be used.

Further, in some embodiments, the non-slip material 116 may encompass the perimeter of the U-shaped configuration 114 entirely whereby the non-slip material 116 does not terminate before the first gripping-tip 122 and the second gripping-tip 132. Additionally, as shown, the body 110 may be substantially flat across a cross-section. In other embodiments, the body 110 may be rounded across the cross-section.

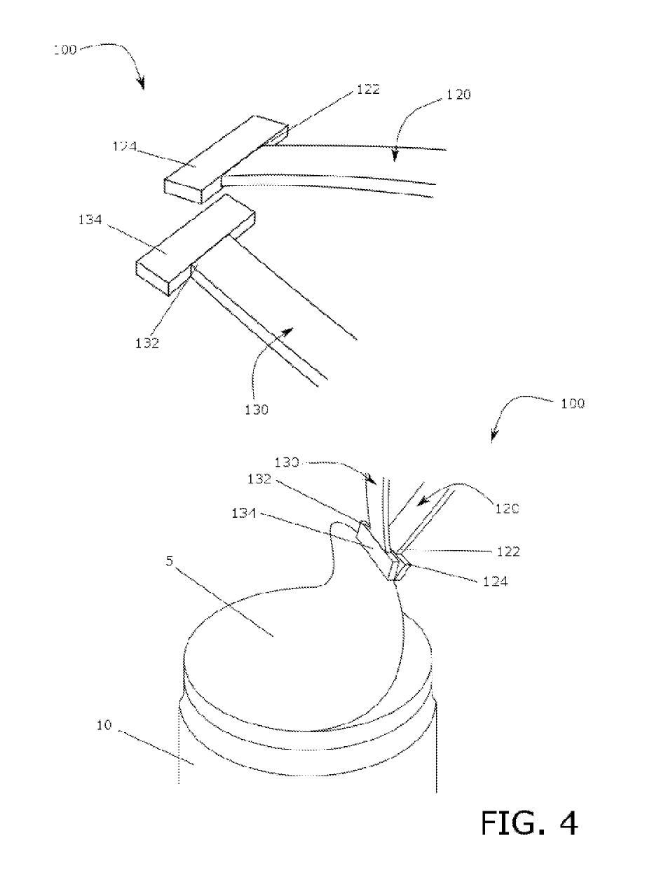

Referring now to FIG. 4 showing different side perspective views of the device 100 of FIG. 1, according to an embodiment of the present disclosure. Illustrated here is the first gripping-tip 122 and the second gripping-tip 132 of the device 100. As shown, the first gripping-tip 122 may include a first gripping-portion 124 configured to provide additional gripping-surface for gripping the seal 5 on the object 10, and similarly, the second gripping-tip 132 may include a second gripping-portion 134 configured to provide the additional gripping-surface for gripping the seal 5 on the object 10. In the preferred embodiment, the first gripping-portion 124 and the second gripping-portion 134 may each include a rectangular-shape and may be made from the rubber material. In another embodiment, the first gripping-portion 124 and the second gripping-portion 134 may each include a square-shape. Further, the first gripping-portion 124 and the second gripping-portion 134 may be made from the silicone material. It should be appreciated that any material may be used.

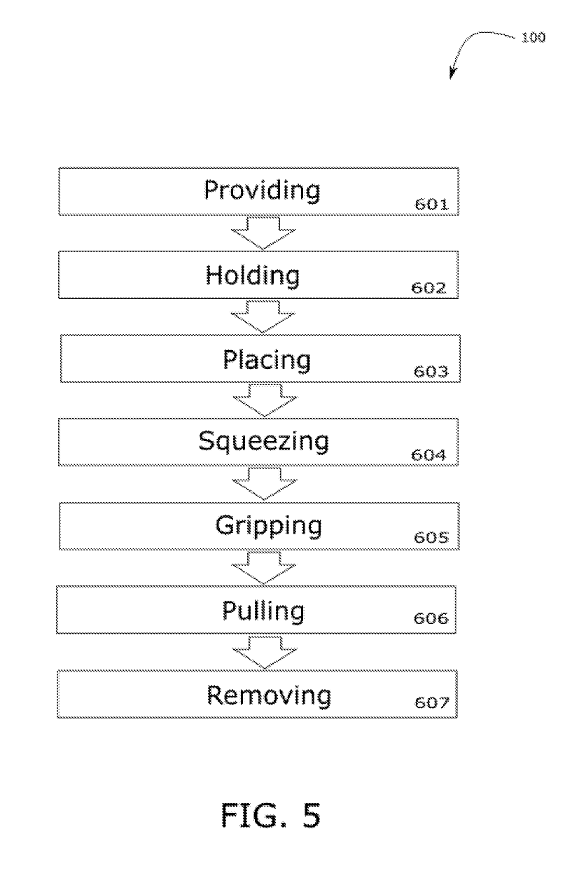

FIG. 5 is a flow diagram illustrating a method of using a device for gripping and removing a seal from an object 500, according to an embodiment of the present disclosure. As illustrated, the method of using a device for gripping and removing a seal from an object 500 may include the steps of: step one 501, providing the device 100 as above; step two 502, holding the handle-means 117; step three 503, placing the seal 5 on the object 10 into the space 148 of the open-configuration 144, between the first gripping-tip 122 and the second gripping-tip 132; step four 504, squeezing the handle-means 117 to move the first arm-member 120 and the second arm-member 130 from the open-configuration 144 into the closed-configuration 146, such that the first gripping-tip 122 and the second gripping-tip 132 biasingly-grip the seal 5 on the object 10; step five 505, gripping the seal 5 on the object 10 with the device 100; step six 506, pulling the seal 5 on the object 10 away from the object 10 with the device 100; and step seven 507, removing the seal 5 from the object 10.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 use (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for gripping and removing a seal from an object, the device comprising:
a body including a continuous length formed into a substantially U-shaped configuration, the U-shaped configuration including:
a first arm-member having a first gripping-tip;
a second arm-member having a second gripping-tip; and
a curved-end connecting the first arm-member and the second arm-member in a substantially arcuate-bend; and
wherein the first arm-member and the second arm-member are able to move between an open-configuration and a closed-configuration, the open-configuration including the first-arm member and the second arm-member being substantially parallel and having a space therebetween, and the closed-configuration including the first gripping-tip and the second-gripping tip being pressed together and being configured to biasingly-grip the seal on the object such that said seal is able to be manipulated in relation to said object.

2. The device of claim 1, wherein the body is made from a flexible, resilient material configured for manipulation between the open-configuration and the closed-configuration.

3. The device of claim 2, wherein the flexible, resilient material is a spring-metal material.

4. The device of claim 2, wherein the flexible, resilient material is a rubber material.

5. The device of claim 2, wherein the flexible, resilient material is a plastic material.

6. The device of claim 1, wherein the body further includes a non-slip material located around a perimeter of the U-shaped configuration and terminating before the first gripping-tip and the second gripping-tip; and
wherein the non-slip material is configured to provide a handle-means for a hand of a user.

7. The device of claim 5, wherein the non-slip material further includes a plurality of finger receiving grooves to provide the user with additional gripping ability.

8. The device of claim 6, wherein the non-slip material is the rubber material.

9. The device of claim 6, wherein the non-slip material is a silicone material.

10. The device of claim 1, wherein the first gripping-tip includes a first gripping-portion configured to provide additional gripping-surface for gripping the seal on the object, said seal being airtight.

11. The device of claim 9, wherein the second gripping-tip includes a second gripping-portion configured to provide the additional gripping-surface for gripping the seal on the object.

12. The device of claim 10, wherein the first gripping-portion and the second gripping-portion each include a rectangular-shape.

13. The device of claim 10, wherein the first gripping-portion and the second gripping-portion each include a square-shape.

14. The device of claim 12, wherein the first gripping-portion and the second gripping-portion are made from the rubber material.

15. The device of claim 12, wherein the first gripping-portion and the second gripping-portion are made from the silicone material.

16. The device of claim 1, wherein the first arm-member and the second arm-member are equal in length.

17. The device of claim 1, wherein the body is substantially flat across a cross-section.

18. A device for gripping and removing a seal from an object, the device comprising:
a body including a continuous length formed into a substantially U-shaped configuration, the U-shaped configuration including:
a first arm-member having a first gripping-tip;
a second arm-member having a second gripping-tip; and
a curved-end connecting the first arm-member and the second arm-member in a substantially arcuate-bend; and
wherein the first arm-member and the second arm-member are able to move between an open-configuration and a closed-configuration, the open-configuration including the first-arm member and the second arm-member being substantially parallel and having a space therebetween, and the closed-configuration including the first gripping-tip and the second-gripping tip being pressed together and being configured to biasingly-grip the seal on the object such that said seal is able to be manipulated in relation to said object; and
wherein the body is made from a flexible, resilient material configured for manipulation between the open-configuration and the closed-configuration;
wherein the flexible, resilient material is a spring-metal material;
wherein the body further includes a non-slip material located around a perimeter of the U-shaped configuration and terminating before the first gripping-tip and the second gripping-tip;
wherein the non-slip material is configured to provide a handle-means for a hand of a user;
wherein the non-slip material further includes a plurality of finger receiving grooves to provide the user with additional gripping ability;
wherein the non-slip material is a rubber material;
wherein the first gripping-tip includes a first gripping-portion configured to provide additional gripping-surface for gripping the seal on the object, said seal being airtight;
wherein the second gripping-tip includes a second gripping-portion configured to provide the additional gripping-surface for gripping the seal on the object;
wherein the first gripping-portion and the second gripping-portion each include a rectangular-shape;
wherein the first gripping-portion and the second gripping-portion are made from the rubber material;
wherein the first arm-member and the second arm-member are equal in length; and
wherein the body is substantially flat across a cross-section.

19. The device of claim 17, further comprising set of instructions; and
wherein the device is arranged as a kit.

20. A method of using a device for gripping and removing a seal from an object, the method comprising the steps of:
providing the device for gripping and removing the seal from the object, the device including:
a body including a continuous length formed into a substantially U-shaped configuration, the U-shaped configuration including:
a first arm-member having a first gripping-tip;
a second arm-member having a second gripping-tip; and
a curved-end connecting the first arm-member and the second arm-member in a substantially arcuate-bend; and
wherein the first arm-member and the second arm-member are able to move between an open-configuration and a closed-configuration, the open-configuration including the first-arm member and the second arm-member being substantially parallel and having a space therebetween, and the closed-configuration including the first gripping-tip and the second-gripping tip being pressed together and being configured to biasingly-grip the seal on the object such that said seal is able to be manipulated in relation to said object;
wherein the body further includes a non-slip material located around a perimeter of the U-shaped configuration and terminating before the first gripping-tip and the second gripping-tip, and wherein the non-slip material is configured to provide a handle-means for a hand of a user;
holding the handle-means;
placing the seal on the object into the space of the open-configuration, between the first gripping-tip and the second gripping-tip;
squeezing the handle-means to move the first arm-member and the second arm-member from the open-configuration into the closed-configuration, such that the first gripping-tip and the second gripping-tip biasingly-grip the seal on the object;
gripping the seal on the object with the device;
pulling the seal on the object away from the object with the device; and
removing the seal from the object.
